(19) United States
(12) Patent Application Publication
(10) Pub. No.: US 2025/0039762 A1
(43) Pub. Date: Jan. 30, 2025

(54) RADIO ACCESS NETWORK LOCAL ROUTER OPTIMIZATION

(71) Applicant: T-Mobile Innovations LLC, Overland Park, KS (US)

(72) Inventors: Roopesh Kumar POLAGANGA, Bothell, WA (US); Sanjay WAJE, Plano, TX (US); Madhav Ram NUSETTY, Snohomish, WA (US); Kurt LANDUYT, Parkville, MO (US)

(21) Appl. No.: 18/357,288

(22) Filed: Jul. 24, 2023

(51) Int. Cl. H04W 40/12; H04W 24/02; H04W 36/14; H04W 36/30

(52) U.S. Cl. CPC H04W 40/12; H04W 24/02; H04W 36/14; H04W 36/304

(57) ABSTRACT

Systems and methods are provided for monitoring one or more connection parameters for a local router. The local router is connected to a cellular network and a mobile phone. If one or more connection parameters satisfy the connection threshold, the local router or the mobile device switch from communicating with the network using a first communication technology to communicate with the network using a second communication technology.

### TECHNICAL BACKGROUND

A wireless network, such as a cellular network, can include an access node (e.g., wireless access node) serving multiple wireless devices or user equipment (mobile device) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages.

5G RATs boost network capacity and allow mobile network operators (MNOs) to provide new router services like local router access via a RAT such as 5G NR, which is cost-effective and efficient alternative for providing broadband. The local router communicates with an access node via a RAT, such as 5G NR, and communicates with a mobile device via a mobile device via a second RAT, such as Wi-Fi.

### OVERVIEW

One aspect of the present disclosure relates to a system configured for managing network resources. The system may include one or more hardware processors configured by machine-readable instructions. The processor(s) may be configured to set a connection threshold for a local router. The local router may be connected to a network and a mobile device. The processor(s) may be configured to monitor one or more connection parameters for the local router. The processor(s) may be configured to, in response to a determination that the one or more connection parameters satisfy the connection threshold, cause the local router or the mobile device to switch from communicating with the network using a first communication technology to communicate with the network using a second communication technology.

In some implementations of the system, the processor(s) may be configured to, in response to a determination that the one or more connection parameters satisfies a connection threshold, cause the local router to switch from communicating with the network using a first communication technology to communicating with the network using a second communication technology.

In some implementations of the system, the first communication technology may be 5G standalone and the second communication technology is 5G non-standalone.

In some implementations of the system, the one or more connection parameters may be one or more of data stalls of the local router when connected to the network, reconnection of the local router to an access node, and transmission control protocol impairment of the local router.

In some implementations of the system, the processor(s) may be configured to, in response to a determination that the connection parameter satisfies a connection threshold, cause the mobile device to switch from connecting to the network using a first communication technology with the local router to connecting directly to the network using a second communication technology.

In some implementations of the system, the first communication technology may be Wi-Fi and the second communication technology is 5G non-standalone or 5G standalone.

In some implementations of the system, the one or more connection parameters may be one or more of domain name service impairment of the mobile device and disconnection and reconnection of the mobile device and the local router.

Another aspect of the present disclosure relates to a method for managing network resources. The method may include setting a connection threshold for a local router. The local router may be connected to a network and a mobile device. The method may include monitoring one or more connection parameters for the local router. The method may include, in response to a determination that the one or more connection parameters satisfy the connection threshold, causing the local router or the mobile device to switch from communicating with the network using a first communication technology to communicate with the network using a second communication technology.

Yet another aspect of the present disclosure relates to a non-transient computer-readable storage medium having instructions embodied thereon, the instructions being executable by one or more processors to perform a method for managing network resources. The method may include setting a connection threshold for a local router. The local router may be connected to a network and a mobile device. The method may include monitoring one or more connection parameters for the local router. The method may include, in response to a determination that the one or more connection parameters satisfy the connection threshold, causing the local router or the mobile device to switch from communicating with the network using a first communication technology to communicate with the network using a second communication technology.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts a wireless network that may be connected to a local router and mobile device, in accordance with disclosed examples.

FIG. 2 depicts a system and a connection optimization engine, in accordance with the disclosed examples.

FIG. 3 depicts a flowchart illustrating an exemplary method for switching the connection of a local router or a mobile device, in accordance with the disclosed examples.

FIG. 4 depicts a flowchart illustrating an exemplary method for switching the connection of a local router, in accordance with the disclosed examples.

FIG. 5 depicts a flowchart illustrating an exemplary method for switching the connection of a mobile device, in accordance with the disclosed examples.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

Mobile devices may be connected to an access node either directly or indirectly. As an example of a direct connection, a mobile device may communicate with the access node via an Enhanced Mobile Broadband (eMBB) protocol, which provides for 5G communication between the mobile device and the access node.

As an example of an indirect connection, a mobile device may communicate with a device such as a local router utilizing Fixed Wireless Access (FWA) Home Internet (HINT) protocol. In such a scenario, the local router communicates with the mobile device via one RAT such as Wi-Fi and communicates with the access node via another RAT such as 5G NR, thus acting as an intermediary to provide indirect communication between the mobile device and the access node.

A mobile device that is co-located with a local router can connect to a cellular network indirectly through a communication technology such as Wi-Fi when connected to the local router and directly via 5G NR when disconnected from the local router. Examples of co-location may include use of a local router and mobile device at the same location, such as a residential location.

When a mobile device is co-located with a local router, the mobile device may be connected to the local router via Wi-Fi. In this system, the local router provides an indirect connection to the network by a first connection to the mobile device via Wi-Fi and a second connection to the network via 5G. However, this system may encounter connection problems.

In the first example, the local router may encounter problems connecting with the gNB to obtain a 5G connection. In a second example, the mobile device may encounter problems connecting with the local router via the Wi-Fi connection.

The connection optimization engine described herein proactively handles these types of breakdowns in connections. Connection optimization identifies and switches RATs (communication technologies) to preserve a consistent user experience on a mobile device. The connection optimization engine identifies issues with the Wi-Fi connection between the mobile device and the local router and causes the mobile device to connect directly with the gNB access node. The connection optimization engine also identifies issues with the 5G connection between the local router and the 5G access node and causes the local router to switch from connecting with the gNB in 5G stand-alone mode to 5G non-standalone with LTE. If the local router is connected with the gNB in 5G non-standalone with LTE mode when it encounters connection issues, the connection optimization engine causes the mobile device to stop using the Wi-Fi connection with the local router and connect directly with the gNB.

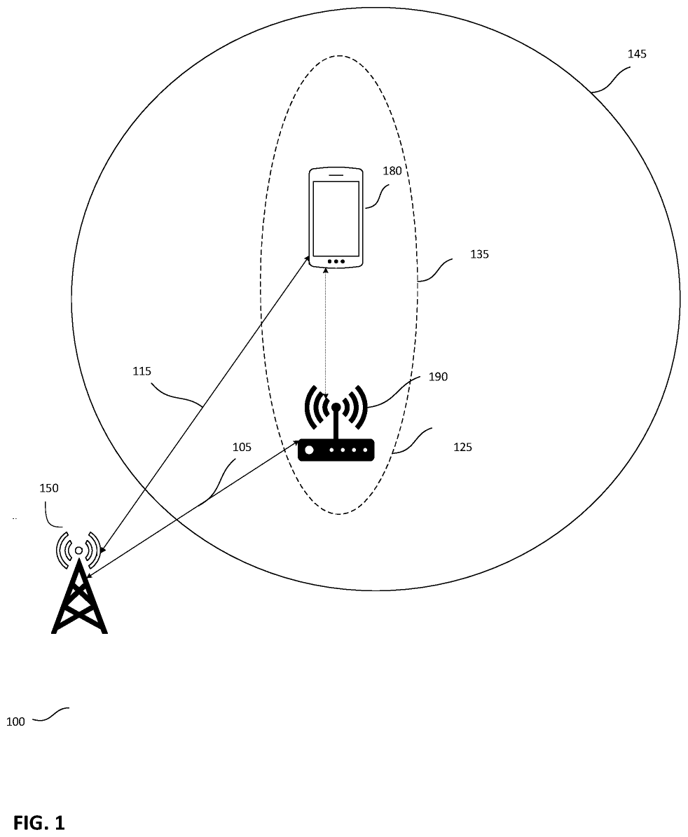

FIG. 1 depicts wireless environment 100 illustrating an access node 150 and local router 190. Wireless environment 100 includes a mobile device 180. The mobile device 180 may be a cell phone, mobile phone, wireless phone, as well as other types of devices or systems that are capable of radio frequency communication. Mobile device 180 is capable of attaching to access node 150. Access node 150 may be operated by a Mobile Network Operator (MNO). While the wireless environment is depicted with a single mobile device 180, single access node 150 and local router 190, it may comprise multiple mobile devices 180, access nodes 120 and local router 190.

Access node 150 may be for a wireless network, such as a cellular network, and can include a core network and a radio access network (RAN) serving multiple mobile devices 180 and local routers 190 in a geographical area covered by a radio frequency transmission provided by the access network. As technology has evolved, different carriers (MNOs) within the cellular network may utilize different types of radio access technologies (RATs) (communication technologies).

RATs can include fifth generation (5G) RATs (new radio (NR)) and 6G. Further, different types of access nodes may be implemented within the access network for deployment for the various RATs. A next generation NodeB (gNB) may be utilized for 5G RATs. Deployment of the evolving RATs in a network provides numerous benefits. For example, newer RATs, such as 5G RATs, may provide additional resources to provide local routers and service to customers. However, mobile devices connected to these local routers in residential homes may cause increased connection issues for the mobile devices.

Local router 190 may be a home router. The local router 190 may be any network device configured to provide wireless communications within a comparatively small (compared to the access node 150) area 135, using one or more RATS (communication technologies) such as WI-FI and Bluetooth. In one particular example, the local router 190 is a HINT router configured to provide communication services using FWA technology.

In FIG. 1, mobile device 180 communicates with a device such as a local router 190 utilizing Fixed Wireless Access (FWA) Home Internet (HINT) protocol. The local router 190 communicates with the mobile device 180 via RAT 125, such as Wi-Fi, and communicates with the access node 150 via RAT 105, such as 5G NR, thus acting as an intermediary to provide indirect communication between the mobile device 180 and the access node 150.

The mobile device 180 is co-located with a local router 190 and can indirectly connect to a cellular network via RAT 125, such as Wi-Fi, when connected to the local router 190 and via RAT 115, such as a direct 5G NR connection, when disconnected from the local router 190.

Local router 190 may encounter problems connecting with access node 150 via RAT 125. For example, local router 190 may experience data stalls, IP connection issues with access node 150 and/or transmission control impairment when connecting with access node 150.

The mobile device 180 may encounter problems connecting with the local router 190 via RAT 125. The connection between the mobile device 180 and local router 190 may experience denial of service (DNS) impairments and/or high disconnects and reconnects between mobile device 180 and local router 190.

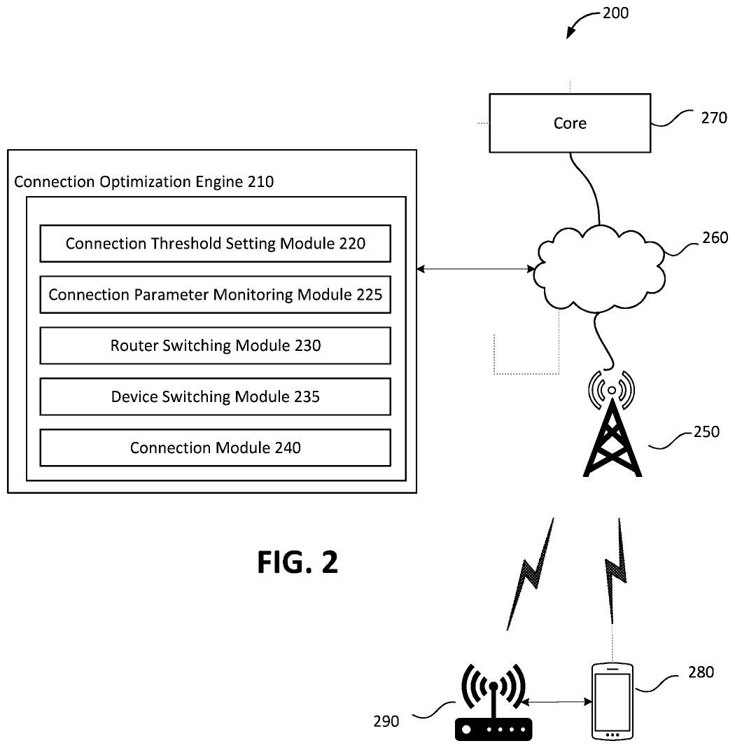

FIG. 2 illustrates a system 200 configured for managing connections in a radio access network, in accordance with one or more implementations.

As illustrated, system 200 comprises connection optimization engine 210, an access node 250, a network 260, a core 270, which provide service in a coverage area, a mobile device 280, and a local router 290. For purposes of illustration and ease of explanation, only one access node 250, mobile device 280 local router 290 are shown in the system 200; however, as noted above with regard to FIG. 1, additional access nodes and/or additional local routers and mobile devices may be present in the system 200.

In the illustration of FIG. 2, the access node 250 is connected to the network 260 via an NR path (including the 5G core 270); however, in practical implementations the access node 250 may be connected to network 260 via multiple paths (e.g., using multiple RATs). The access node 250 may communicate with the core 270 via one or more communication links, each of which may be a direct link. However, it will be appreciated that network 260 may be any type of network facilitating communication among connection optimization engine 210, access node 250, local router 269, core 270, and mobile device 280.

The access node 250 may be any network node configured to provide communications between the connected wireless devices. As examples of a standard access node, the access node 250 may be a gNodeB in 5G networks, an eNodeB in 4G/LTE networks, or the like, including combinations thereof. Access node 250 and core 270 may also provide data to connection optimization engine 210.

The local router 290 and mobile device 280 may utilize the same mobile network operator. The local router 290 may be connected to access node 250 and mobile device 280. The mobile device 280 may be connected indirectly to a cellular network through the local router 290 using a first communication technology, such as WI-FI.

The mobile device 280 may switch from indirect connection to the cellular network via a Wi-Fi connection with local router 290 to a direct 5G connection with a gNB by for direct access to a cellular network 260 of a mobile network operator. The direct access to the cellular network 260 may be for a set duration before the mobile device 280 reestablishes an indirect connection with the cellular network 260 through local router 290.

A connection optimization engine 210 is in communication with the access node 250 and/or the core 270. Connection optimization engine 210 may be configured for managing radio access network connections. Connection optimization engine 210 identifies inconsistent connections between the local router 290 and access node 250 and/or inconsistent connections between the local router 290 and mobile device 280.

The connection optimization engine 210 can comprise one or more electronic processors and associated circuitry to execute or direct the execution of computer-readable instructions such as those described herein. In so doing, the connection optimization engine 210 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof. Moreover, the connection optimization engine 210 can receive instructions and other input at a user interface.

As illustrated the connection optimization engine 210 utilizes a modular controller, a memory, wireless communication circuitry, and a bus through which the various elements of the connection optimization engine 210 may communicate with access node 250, core 270, and mobile device 280, local router 290. The modular controller is one example of an electronic processor, and may include sub-modules or units, each of which may be implemented via dedicated hardware (e.g., circuitry), software modules which are loaded from the memory and processed by the controller, firmware, and the like, or combinations thereof.

The instruction modules may include one or more of connection threshold setting module 220, connection parameter monitoring module 225, router switching module 230, device switching module 235, device connection module 240, and/or other instruction modules. Some or all of the sub-modules or units may physically reside within the controller or may instead reside within the memory and/or may be provided as separate units, in any combination. The various sub-modules or units may include or implement logic circuits, thereby performing operations such as setting parameters, monitoring parameters, comparing parameters, and generating instructions.

While FIG. 2 illustrates the connection threshold setting module 220, connection parameter monitoring module 225, router switching module 230, device switching module 235, device connection module 240, as being separate modules, in practical implementations some of the modules may be combined with one another and/or may share components. The connection threshold setting module 220, connection parameter monitoring module 225, router switching module 230, device switching module 235, device connection module 240, may be configured to perform various operations to implement methods in accordance with the present disclosure. While one example of operations performed by the modules is described here, in practical implementations at least some of the operations described as being performed by one module may instead be performed by another module, including a module not explicitly named here.

Connection threshold setting module 220 may be configured to set a connection threshold for a local router 290. The connection thresholds may be set for a local router 290 for a variety of connection parameters including the data stalls of the local router 290, number of disconnections and reconnections between the local router 290 and access node 250, and transmission control impairments for the local router 290 when connected to access node 250. Other parameters may include a number of disconnections and reconnections between mobile device 280 and local router 290 and domain name service (DNS) impairment for mobile device 280 when connected the mobile device 280 is connected to local router 290. The connection thresholds may be configured using one or more of the connection parameters.

Connection parameter monitoring module 225 may be configured to monitor one or more connection parameters for the local router 290. In one example. The connection parameters are for the connection between the local router 290 and access node 250. By way of non-limiting example, the one or more connection parameters may be one or more of data stalls of the local router 290 when connected to the cellular network, number of disconnections and reconnections of the local router 290 to access node 250, and transmission control protocol impairment of the local router 290. Other parameters may include a number of disconnections and reconnections between mobile device 280 and local router 290 and domain name service (DNS) impairment for mobile device 280 when connected the mobile device 280 is connected to local router 290. The connection parameters may be communicated from the local router 290 to the connection optimization engine 210 for monitoring.

Router switching module 230 may be configured to, in response to a determination that the one or more connection parameters satisfy the connection threshold, cause the local router to switch from communicating with the network using a first communication technology to communicate with the network using a second communication technology. In some instances, local router 290 switch from 5G standalone (5G SA) to 5G non-standalone (5G NSA) can improve the local router 290 connection with access node 250. 5G NSA is aided by existing 4G infrastructure and may have more capacity, more bandwidth, lower latency, and increased delivery efficiency than 5G SA.

Router switching module 230 may be configured to, in response to a determination that the one or more connection parameters satisfies a connection threshold, cause the local router to switch from communicating with the network using a first communication technology to communicating with the network using a second communication technology. In instances where the connection parameters satisfy the connection threshold, and the first communication technology is 5G standalone (5G SA), the router switching module 230 switches from the local router 290 communicating with access node 250 with a first communication technology (5G SA), to a second communication technology (5G NSA) to improve connections between the local router 290 and access node 250.

Device switching module 235 may be configured to, in response to a determination that one or more connection parameters satisfy a connection threshold, cause the mobile device 280 to switch from indirect connection to the cellular network through local router 290 using a first communication technology, using direct connection with the cellular network using a second communication technology.

In one example, connection parameters between the mobile device 280 and local router 290 are monitored and if a connection threshold is satisfied, the mobile device 280 switches from using an indirect connection with the local router to a direct cellular connection. For example, the mobile device 280 switches from an indirect connection with a cellular connection using the first communication technology, such as WI-FI, to direct connection with the cellular network using a second communication technology, such as 4G LTE, 5G non-standalone or 5G standalone.

It should be appreciated that although modules 220, 225, 230, 235, and/or 240 are illustrated in FIG. 2 as being implemented within a single processing unit, in implementations in which processor(s) 255 includes multiple processing units, one or more of modules 220, 225, 230, 235, and/or 240 may be implemented remotely from the other modules. The description of the functionality provided by the different modules 220, 225, 230, 235, and/or 240 described below is for illustrative purposes, and is not intended to be limiting, as any of modules 220, 225, 230, 235, and/or 240 may provide more or less functionality than is described. For example, one or more of modules 220, 225, 230, 235, and/or 240 may be eliminated, and some or all of its functionality may be provided by other ones of modules 220, 225, 230, 235, and/or 240. As another example, processor(s) 255 may be configured to execute one or more additional modules that may perform some or all of the functionality attributed below to one of modules 220, 225, 230, 235, and/or 240.

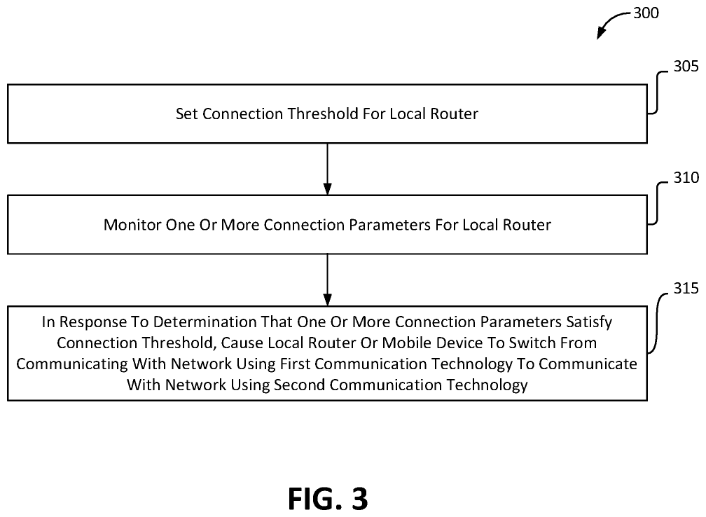

FIGS. 3, 4 and 5 illustrate an exemplary process flow for managing network resources. The operations of FIGS. 3, 4 and 5 will be described as being performed by the connection optimization engine for purposes of explanation. In other implementations, the operations may be performed by or under the control of a processor of a wireless access node, 5G core or processed in a cloud environment.

FIGS. 3, 4 and 5 illustrate methods 300, 400 and 500 for managing radio access network connections, in accordance with one or more implementations. The operations of methods 300, 400 and 500 presented below are intended to be illustrative. In some implementations, methods 300, 400 and 500 may be accomplished with one or more additional operations not described, and/or without one or more of the operations discussed. Additionally, the order in which the operations of methods 300, 400 and 500 are illustrated in FIGS. 3, 4 and 5 and described below is not intended to be limiting.

In some implementations, methods 300, 400 and 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 300, 400 and 500 in response to instructions stored electronically on an electronic storage medium. The one or more processing devices may include one or more devices configured through hardware, firmware, and/or software to be specifically designed for execution of one or more of the operations of methods 300, 400 and 500.

With reference to FIG. 3, the process flow begins at operation 305, setting a connection threshold for a local router. The local router may be connected to a network and a mobile device. The connection threshold is set based on one or more connection parameters between the local router, access node and/or mobile device. The parameters may be one or more of data stalls of the local router when connected to an access node, number of disconnections and reconnections of the local router to the access node, and transmission control protocol impairment of the local router. Other parameters may include a number of disconnections and reconnections between mobile device and local router and domain name service (DNS) impairment for mobile device when connected the mobile device is connected to local router.

At operation 310, the processor performs the operation of monitoring one or more connection parameters for the local router. The connection parameters may be communicated from the local router to the connection optimization engine for monitoring.

At operation 315, in response to a determination that the one or more connection parameters satisfy the connection threshold, the processor performs the operation of causing the local router or the mobile device to switch from communicating with the network using a first communication technology to communicate with the network using a second communication technology.

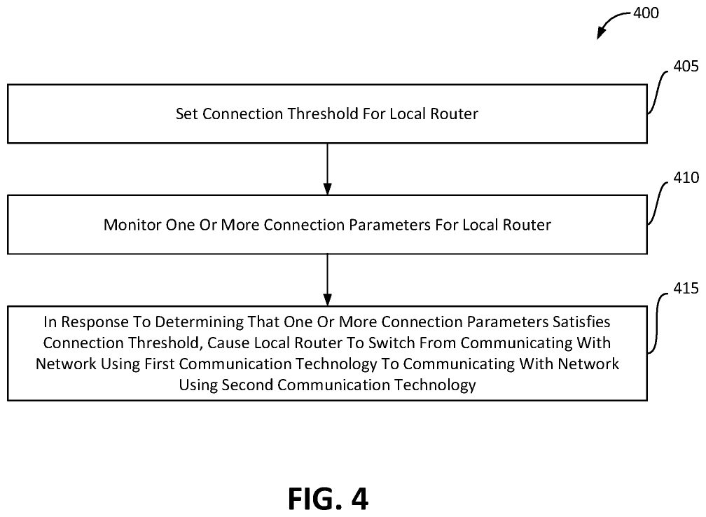

With reference to FIG. 4, the process flow begins at operation 405, setting a connection threshold for a local router. The local router may be connected to a network and a mobile device. The connection threshold is set based on one or more connection parameters between the local router, access node and/or mobile device. The parameters may be one or more of data stalls of the local router when connected to an access node, number of disconnections and reconnections of the local router to the access node, and transmission control protocol impairment of the local router. Other parameters may include a number of disconnections and reconnections between mobile device and local router and domain name service (DNS) impairment for mobile device when connected the mobile device is connected to local router.

At operation 410, the processor performs monitoring of one or more connection parameters for the local router. The connection parameters may be communicated from the local router to the connection optimization engine for monitoring.

At operation 415, in response to a determination that the one or more connection parameters satisfy the connection threshold, the processor causes the local router to switch from communicating with the network using a first communication technology to communicate with the network using a second communication technology.

In one example, if the local router has high data stalls while connected to an access node for a pre-defined time duration, the connection threshold is satisfied. In this example, the local router is connected to the access node using 5G SA. To improve the connection, the local router switches from communicating with the network using a first communication technology (5G SA) for communicating with the network to a second communication technology (5G NSA).

In another example, if the local router has high disconnections and reconnections while connected to an access node for a pre-defined time duration, the connection threshold is satisfied. In this example, the local router is connected to the access node using 5G SA. To improve the connection, the local router switches from communicating with the network using a first communication technology (5G SA) for communicating with the network to using a second communication technology (5G NSA).

In another example, if the local router has high TCP impairments while connected to an access node for a pre-defined time duration, the connection threshold is satisfied. In this example, the local router is connected to the access node using 5G SA. To improve the connection, the local router switches from communicating with the network using a first communication technology (5G SA) for communicating with the access node to using a second communication technology (5G NSA).

In another example, if the mobile device experiences high DNS impairments for a pre-defined time duration, the connection threshold is satisfied. In this example, the local router is connected to the access node using 5G SA. To improve the connection, the local router switches from communicating with the network using a first communication technology (5G SA) to communicating with the access node using a second communication technology (5G NSA).

In another example, if there are high disconnects and reconnects between the local router and mobile device for a pre-defined time duration, the connection threshold is satisfied. In this example, the local router is connected to the access node using 5G SA. To improve the connection, the local router switches from communicating with the network using a first communication technology (5G SA) to communicating with the access node to using a second communication technology (5G NSA).

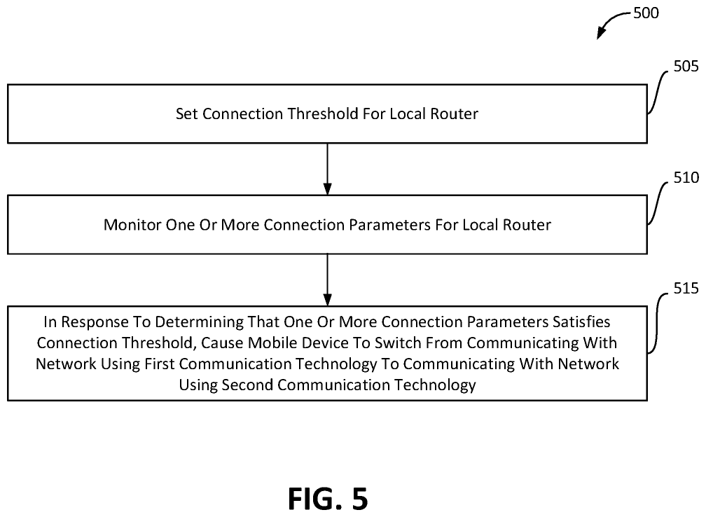

With reference to FIG. 5, the process flow begins at operation 505, setting a connection threshold for a local router. The local router may be connected to a network and a mobile device. The connection threshold is set based on one or more connection parameters between the local router, access node and/or mobile device. The parameters may be one or more of data stalls of the local router when connected to an access node, number of disconnections and reconnections of the local router to the access node, and transmission control protocol impairment of the local router. Other parameters may include a number of disconnections and reconnections between mobile device and local router and domain name service (DNS) impairment the mobile device is connected to local router.

At operation 510, the processor performs monitoring of one or more connection parameters for the local router. The connection parameters may be communicated from the local router to the connection optimization engine for monitoring.

At operation 515, in response to a determination that the one or more connection parameters satisfy the connection threshold, the processor causes the local router to switch from communicating with the network using a first communication technology to communicate with the network using a second communication technology.

In one example, if the local router has high data stalls while connected to an access node for a pre-defined time duration, the connection threshold is satisfied. In this example, the mobile device is connected to the local router via WI-FI. The local router is connected to the access node using 4G LTE or 5G NSA. To improve the connection of the mobile device, the mobile device switches from communicating indirectly with the network via local router using a first communication technology, such as WI-FI, to communicate directly with the network using a second communication technology, such as 4G LTE, 5G NSA or 5G SA.

In another example, if the local router has high disconnections and reconnections while connected to an access node for a pre-defined time duration, the connection threshold is satisfied. In this example, the mobile device is connected to the local router via WI-FI. The local router is connected to the access node using 4G LTE or 5G NSA. To improve the connection of the mobile device, the mobile device switches from communicating indirectly with the network via local router using a first communication technology, such as WI-FI, to communicate with directly the network using a second communication technology, such as 4G LTE, 5G NSA or 5G SA.

In another example, if the local router has high TCP impairments while connected to an access node for a pre-defined time duration, the connection threshold is satisfied. In this example, the mobile device is connected to the local router via WI-FI. The local router is connected to the access node using 4G LTE or 5G NSA. To improve the connection of the mobile device, the mobile device switches from communicating indirectly with the network via local router using a first communication technology, such as WI-FI, to communicate with directly the network using a second communication technology, such as 4G LTE, 5G NSA or 5G SA.

In another example, if the mobile device experiences high DNS impairments for a pre-defined time duration, the connection threshold is satisfied. In this example, the mobile device is connected to the local router via WI-FI. The local router is connected to the access node using 4G LTE or 5G NSA. To improve the connection of the mobile device, the mobile device switches from communicating indirectly with the network via local router using a first communication technology, such as WI-FI, to communicate with directly the network using a second communication technology, such as 4G LTE, 5G NSA or 5G SA.

In another example, if there are high disconnects and reconnects between the local router and mobile device for a pre-defined time duration, the connection threshold is satisfied. In this example, the mobile device is connected to the local router via WI-FI. The local router is connected to the access node using 4G LTE or 5G NSA. To improve the connection of the mobile device, the mobile device switches from communicating indirectly with the network via local router using a first communication technology, such as WI-FI, to communicate with directly the network using a second communication technology, such as 4G LTE, 5G NSA or 5G SA.

The operations of FIGS. 3, 4 and 5 need not necessarily be performed one after another in immediate sequence. While the above descriptions illustrate various aspects of the present disclosure, the present disclosure is not so limited. The methods and operations described above may be performed in an iterative matter. These additional iterations may also be reverted in a manner similar to that described above.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system configured for managing network resources, the system comprising:
one or more hardware processors configured by machine-readable instructions to:
set a connection threshold for a local router, the local router being connected to a network and a mobile device;
monitor one or more connection parameters for the local router; and
in response to a determination that the one or more connection parameters satisfy the connection threshold, cause the local router or the mobile device to switch from communicating with the network using a first communication technology to communicate with the network using a second communication technology.

2. The system of claim 1, wherein the one or more hardware processors are further configured by machine-readable instructions to:
in response to the determination that the one or more connection parameters satisfies the connection threshold, cause the local router to switch from communicating with the network using the first communication technology to communicating with the network using the second communication technology.

3. The system of claim 2, wherein the first communication technology is 5G standalone and the second communication technology is 5G non-standalone.

4. The system of claim 3, wherein the one or more connection parameters is one or more of data stalls of the local router when connected to the network, reconnection of the local router to an access node, and transmission control protocol impairment of the local router.

5. The system of claim 1, wherein the one or more hardware processors are further configured by machine-readable instructions to:
in response to the determination that the one or more connection parameters satisfy the connection threshold, cause the mobile device to switch from connecting to the network using the first communication technology with the local router to connecting to directly to the network using the second communication technology.

6. The system of claim 5, wherein the first communication technology is Wi-Fi and the second communication technology is 5G non-standalone or 5G standalone.

7. The system of claim 6, wherein the one or more connection parameters is one or more of domain name service impairment of the mobile device and disconnection and reconnection of the mobile device and the local router.

8. A method of managing network resources, comprising:
setting a connection threshold for a local router, the local router being connected to a network and a mobile device;
monitoring one or more connection parameters for the local router; and
in response to a determination that the one or more connection parameters satisfy the connection threshold, causing the local router or the mobile device to switch from communicating with the network using a first communication technology to communicate with the network using a second communication technology.

9. The method of claim 8, further comprising:
in response to the determination that the one or more connection parameters satisfies the connection threshold, causing the local router to switch from communicating with the network using the first communication technology to communicating with the network using the second communication technology.

10. The method of claim 9, wherein the first communication technology is 5G standalone and the second communication technology is 5G non-standalone.

11. The method of claim 10, wherein the one or more connection parameters is one or more of data stalls of the local router when connected to the network, reconnection of the local router to an access node, and transmission control protocol impairment of the local router.

12. The method of claim 8, further comprising:
in response to the determination that the one or more connection parameters satisfy the connection threshold, causing the mobile device to switch from connecting to the network using the first communication technology with the local router to connecting to directly to the network using the second communication technology.

13. The method of claim 12, wherein the first communication technology is Wi-Fi and the second communication technology is 5G non-standalone or 5G standalone.

14. The method of claim 13, wherein the one or more connection parameters is one or more of domain name service impairment of the mobile device and disconnection and reconnection of the mobile device and the local router.

15. A non-transient computer-readable storage medium having instructions embodied thereon, the instructions being executable by one or more processors to perform a method for managing network resources, the method comprising:
setting a connection threshold for a local router, the local router being connected to a network and a mobile device;
monitoring one or more connection parameters for the local router; and
in response to a determination that the one or more connection parameters satisfy the connection threshold, causing the local router or the mobile device to switch from communicating with the network using a first communication technology to communicate with the network using a second communication technology.

16. The computer-readable storage medium of claim 15, wherein the method further comprises:
in response to the determination that the one or more connection parameters satisfies the connection threshold, causing the local router to switch from communicating with the network using the first communication technology to communicating with the network using the second communication technology.

17. The computer-readable storage medium of claim 16, wherein the first communication technology is 5G standalone and the second communication technology is 5G non-standalone.

18. The computer-readable storage medium of claim 17, wherein the one or more connection parameters is one or more of data stalls of the local router when connected to the network, reconnection of the local router to an access node, and transmission control protocol impairment of the local router.

19. The computer-readable storage medium of claim 15, wherein the method further comprises:
in response to the determination that the one or more connection parameters satisfy the connection threshold, causing the mobile device to switch from connecting to the network using the first communication technology with the local router to connecting to directly to the network using the second communication technology.

20. The computer-readable storage medium of claim 19, wherein the first communication technology is Wi-Fi and the second communication technology is 5G non-standalone or 5G standalone.
